(19) United States
(12) Patent Application Publication
(10) Pub. No.: US 2003/0174739 A1
(43) Pub. Date: Sep. 18, 2003

(54) Termination equipment with an overhead processor programmable to pass through proprietary usage data in selected overhead data slots

(76) Inventor: Ronald J. Gagnon, Nepean (CA)

Correspondence Address: SMART & BIGGER, 1000 de la GAUCHETIERE ST. WEST, Suite 3400, Montreal, Quebec, H3B 4W5, CA

(21) Appl. No.: 10/095,002

(22) Filed: Mar. 12, 2002

(51) Int. Cl. H04J 3/02

(52) U.S. Cl. 370/539; 370/541

(57) ABSTRACT

The invention provides a termination equipment for use in a data network such as a SONET data network. The termination equipment has a data input for receiving a plurality of data frames, each data frame including an overhead component and a payload component. An overhead processor performs a termination operation on the overhead components of the data frames. The overhead processor has a control input to receive control information designating at least one data slot of the overhead component to be preserved during the termination operation. The overhead processor is responsive to the control information to perform a selective termination operation on the plurality of data frames, preserving data in the at least one data slot designated for preservation. The selective termination operation produces an output data stream containing payload data from the payload components of the plurality of data frames and data from the at least one data slot designated for preservation.

### FIELD OF THE INVENTION

The invention relates to termination equipment for use in a data network such as a SONET data network. The termination equipment has an overhead processor to perform a termination operation on data frames. The overhead processor is programmable such as to preserve data in selected data slots of the overhead components of the data frames that would otherwise be lost during the termination operation.

### BACKGROUND OF THE INVENTION

Data networks, such as SONET networks, transmit the data as frames from one node to another. In the case of SONET, the overhead component of the data frame is designed to convey a significant amount of information that allows simpler multiplexing and greatly expands operations, administration and maintenance. This overhead information is distributed in data slots that are byte-sized, where each data slot contains data having a well-defined purpose.

Some equipment manufacturers design SONET compliant network elements with added features such as the ability to transmit proprietary usage data embedded in the SONET frame. This is done by placing the data in data slots of the overhead component of the data frame. Since the replacement of the SONET overhead information by proprietary usage data will disable one or more features of the SONET overhead information functionality, those data slots are selected in a way to reduce the negative impact of this loss of functionality. The choice of data slots to use can vary from one manufacturer to another and also can vary according to the specific applications where some overhead information functions are more important than others.

The ability to exchange proprietary information between two network elements is compromised when the network architecture is such that the data frames pass via an intermediate network element, from a different manufacturer. The intermediate network element, which will typically perform a termination operation on the SONET data frames, is not designed to pass through the proprietary usage data and as such the proprietary usage data will be lost.

Against this background there is clearly a need to provide a network element that can pass through proprietary usage data embedded in data frames, even in instances where the location of the proprietary usage data in the data frame can vary from one application to another.

### SUMMARY OF THE INVENTION

The invention provides a termination equipment for use in a data network such as a SONET data network. The termination equipment has a data input for receiving a plurality of data frames, each data frame including an overhead component and a payload component. An overhead processor performs a termination operation on the overhead components of the data frames. The overhead processor has a control input to receive control information designating at least one data slot of the overhead component to be preserved during the termination operation. The overhead processor is responsive to the control information to perform a selective termination operation on the plurality of data frames, preserving data in the at least one data slot designated for preservation. The selective termination operation produces an output data stream containing payload data from the payload components of the plurality of data frames and data from the at least one data slot designated for preservation.

The advantage of this termination equipment is the ability to select, via the control input of the overhead processor, which data slots will be preserved during the termination operation. Accordingly, the termination equipment has the flexibility to work with a wide range of network equipments that may be designed to communicate with one another by sending proprietary usage data in one or more data slots of the overhead component of the data frames. When the selection of the data slots to preserve is properly done, the proprietary usage data will be successfully passed through instead of being destroyed during the termination operation.

In one specific example of implementation, the termination equipment includes a selection module that outputs the control information, which is supplied to the control input of the overhead processor. The selection module performs an analysis of at least some of the data slots of the overhead components of the data frames received at the data input to detect bit patterns which are unlikely to exist if the overhead component contains only genuine SONET information. When such bit patterns are detected, the selection module assumes that the corresponding data slots are used for passing proprietary usage data and issues the control information designating these slots for preservation.

In a possible variant, the selection module communicates with one or more remote equipments that originate the data frames received at the data input to establish their identity. Once the identity is established, the selection module searches a database, which associates remote equipments with the data slots in which proprietary usage data will be placed by those remote equipments. The database search retrieves the identity of the specific data slots to be preserved for the particular remote equipments originating the data frames. The selection module then sends the appropriate control information to the overhead processor.

In another variant, the selection module has a user interface allowing a user to input information permitting to identify the data slots to be preserved. The information input by the user may explicitly identify the data slots to be preserved or it may identify the remote equipment that will be originating the data frames. In the latter case, a database search as in the case of the previous variant yields the identity of the data slots to preserve.

In a second broad aspect, the invention provides a method for processing data frames, each data frame including an overhead component and a payload component. The method includes receiving the data frames at a data input and also receiving control information designating at least one data slot among the plurality of data slots of the overhead components for preservation. The method then includes performing selective termination on the data frames on the basis of the control information to produce an output data stream containing payload data from the payload components of the plurality of data frames and data from the at least one data slot of the overhead component designated for preservation in each data frame.

### BRIEF DESCRIPTION OF THE DRAWINGS

A detailed description of examples of implementation of the present invention is provided hereinbelow with reference to the following drawings, in which:

FIG. 1 is a block diagram of a SONET network segment;

FIG. 2 illustrates a SONET data frame;

FIG. 3 is a more detailed block diagram of termination equipment used in the SONET network segment of FIG. 1, according to a first embodiment of the invention;

FIG. 4 is a detailed block diagram of the termination equipment of FIG. 3, according to a second embodiment of the invention; and

FIG. 5 is a detailed block diagram of the termination equipment of FIG. 3 according to a third embodiment of the invention.

Similar or identical components are designated throughout the drawings with identical reference numerals.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

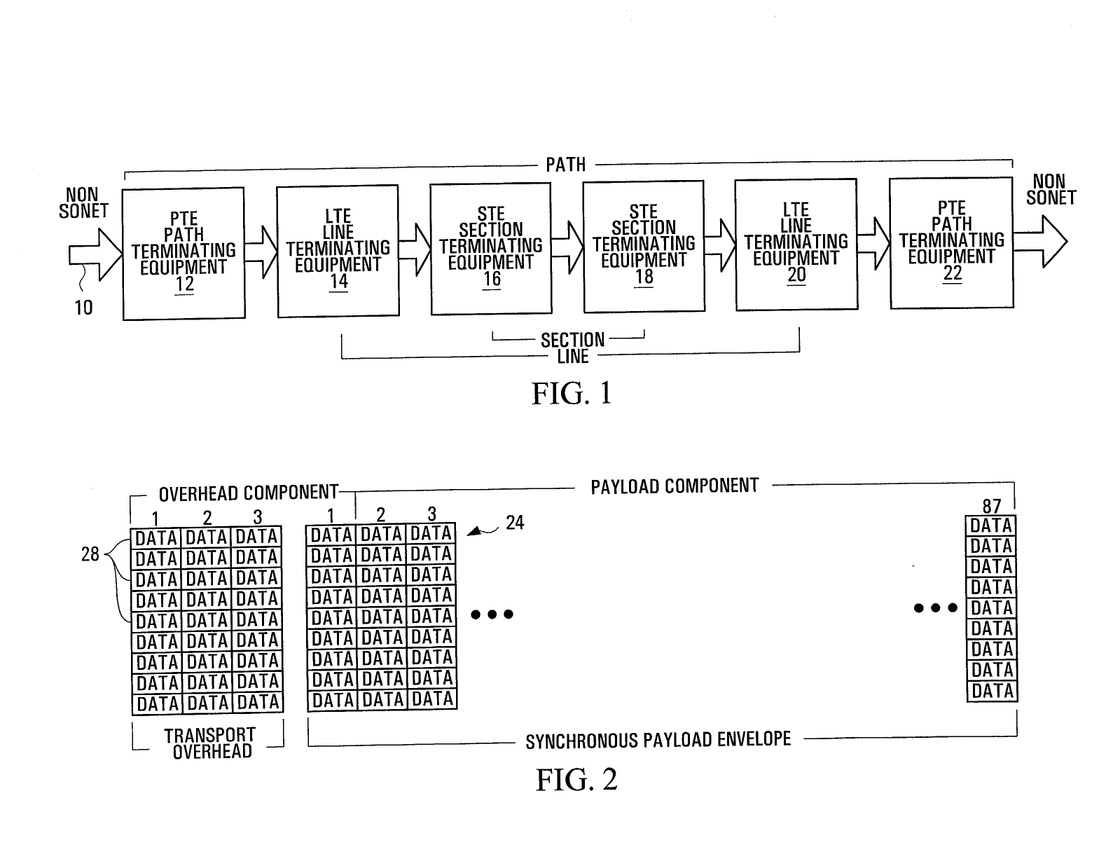

FIG. 1 is a general block diagram of a network segment that uses the SONET protocol. For instance, the network segment can be used to provide Transparent Multiplexing/Demultiplexing. The network segment receives as input at 10 non-SONET data. The non-SONET data is input in a path terminating equipment (PTE) 12 that forms the ingress point of the path layer of the SONET domain. Typically, the PTE 12 produces a SONET data frame. The SONET data frame released by the PTE 12 is received by a line terminating equipment (LTE) 14 that is the ingress point of the line layer of the SONET domain. The LTE 14 performs line termination, among other operations. The SONET data frame output from the LTE 14 is passed to a section terminating equipment (STE) 16 forming the ingress point of the section layer of the SONET domain. The STE 16 performs section termination, among other operations.

At STE 18, LTE 20 and PTE 22, which form the egress points of the section layer, the line layer and the path layer, the SONET data frames are subjected to section termination, line termination and path termination, respectively. At PTE 22, the data leaves the SONET domain.

A typical SONET data frame is shown at FIG. 2. This representation is valid for a synchronous transport signal (STS) 1. The SONET data frame 24 has two main components, namely the overhead component and the payload component. The overhead component has three segments, namely the section, line and path segments. The overhead and payload components of the data frame 24 are divided into data slots 28 that contain information. Typically, the data slots 28 are byte-sized, but this is not an essential requirement. From a logical point of view, the data slots 28 are organized as a table having 90 columns and 9 rows. The first three columns form the transport overhead that contains the section and line overhead segments. The remaining 87 columns form the synchronous payload envelope. The first column of the synchronous payload envelope forms the path overhead segment. Columns 2 to 87 are reserved primarily for payload data. For more information on the structure of the SONET data frame 24, the reader is invited to refer to the relevant technical documentation.

Each one of the terminating equipments PTE 12, LTE 14, STE 16, STE 18, LTE 20 and PTE 22 receives as input data frames and performs various types operations on those data frames. One of these operations is a termination operation. Generally, the termination operation is well known in the art and needs not be described in detail. For information, the reader is invited to refer to the relevant technical documentation.

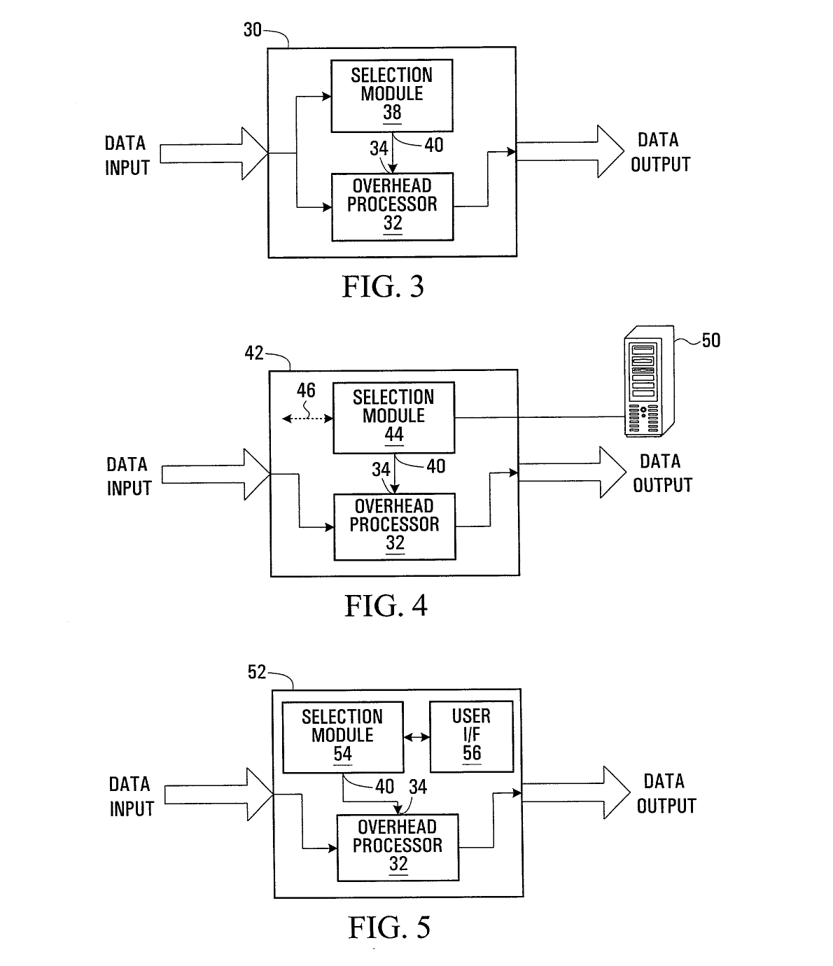

FIG. 3 is a generic representation of a module 30 that performs a termination operation. This generic representation is valid for anyone of the terminating equipments PTE 12, LTE 14, STE 16, STE 18, LTE 20 and PTE 22 with the caveat that in the case of PTE 12 the input receives non-SONET data and in the case of PTE 22 the output is non-SONET data.

The module 30 receives at its data input SONET data frames (this is in the case of LTE 14, STE 16, STE 18 and LTE 20). An overhead processor 32 is in communication with the data input to receive the data frames. The overhead processor 32 will separate the overhead component from the payload component and then perform the termination operation. The overhead processor 32 has a control input 34 that receives control information. The control information designates one or more data slots in the overhead component of each data frame on which the termination operation is not to be performed. In other words, the overhead processor 32 will perform a selective termination operation, preserving the data in the one or more data slots designated by the control information. In one specific example, preserving the data involves reading the data in the one or more data slots and then writing the data in one or more data slots of the overhead component produced by the termination operation.

In the output data, the preserved component may be in the same position in which it appeared at the input data. It may also be moved to a different position in the output frame. In one specific example, one or more byte sized data slots in the unused D4 area of an STS-48 (STS-1 #2 to STS-1 #48) frame can be used for the transport of proprietary usage data. If the preserved component is moved, it may be copied back to its original position at the egress point. It may also be copied into a different position at the egress point if so desired.

The selection of the data slots in the incoming overhead component (the overhead component prior the terminating operation) to be preserved is effected by a selection module 38. The selection module 38 is in communication with the data input of the module 30 and thus it receives the overhead components of the data frames prior the terminating operation. In general, the selection module 38 performs three operations. The first operation is to analyze the data in one or more data slots of the overhead components. The second step is to select, on the basis of the analysis, which data slots should be designated for preservation. The final step is to generate the control information at output 40, which leads to control input 34.

The selection module performs the analysis operation by observing the bits in one or more data slots of the incoming overhead components to determine if the data is of proprietary nature, in other words unlikely to be genuine SONET overhead information. The number and the location of the data slots that are analyzed can vary. This parameter can be set at design time or it can be made user programmable. Generally, it is considered unnecessary to analyze all the data slots in an overhead component because at least some of the data slots carry critical SONET overhead information that cannot be of proprietary nature. The type of data slots in which proprietary information is likely to be found can vary from one application to another and it is well within the reach of a person skilled in the art to make the determination as to which data slots to analyze.

The analysis operation involves observing the bits in the data slots to be analyzed to identify bit patterns indicating proprietary information. A bit pattern indicating proprietary usage is a bit pattern that is unlikely to exist if the overhead component contains only genuine SONET information. The bit patterns that are unlikely to arise are very specific to the intended application and depend to a large degree of the position of the data slots that are being observed. Any ambiguity as to whether a bit pattern is genuine SONET overhead information or proprietary information can be resolved by extending the analysis to more than one data frame to determine if the bit pattern repeats itself, which is a stronger indication of proprietary usage.

Once the analysis is completed, the selection module 38 selects the data slots that have been identified as likely to convey information of proprietary nature, and builds the control information in the form of a suitable signal or message that is released from output 40 and delivered to control input 34. In response to this control message, the overhead processor 32 will preserve the data in the data slots designated for preservation during the termination operation, instead of treating the data in those data slots as per the SONET protocol.

After the termination operation is completed, the overhead processor assembles the overhead component it produced with the payload component to form a SONET data frame 24 that is then released from the output of the overhead processor 32 toward the data output 36 of the module 30. In the case of PTE 12, LTE 14, STE 16, STE 18 and LTE 20, the data output is in the form of SONET data frames 24. In the case of PTE 22, the data is released in non-SONET format.

A second example of implementation is shown at FIG. 4. The selection module 44 communicates with the remote equipment that is the originator of the proprietary usage data inserted in one or more data slots of the overhead components of the SONET data frames 24. Such communication is shown in FIG. 4 by the dotted arrow 46. The communication can occur over a dedicated communication link or over a channel implemented over the SONET network segment. It is preferable that such communication link or channel be bi-directional. The purpose of the communication 46 is to allow the selection module 44 to determine the identity of the remote equipment that originates the proprietary usage data. Any suitable auto-discovery protocol can be used for this purpose. Once the identity of the remote equipment originator of the proprietary usage data has been made, the selection module communicates with a database server 50 over a communication link 48. The database server 50 contains a database that associates remote equipments with the data slots in which proprietary usage data will be placed by those remote equipments. The server receives over the communication link 48 information about the identity of the remote equipment and on the basis of this information, it searches the database to find for that particular remote equipment which are the data slots in which proprietary usage data will be placed, and consequently that should be preserved during the termination operation.

The database server 50 returns to the selection module 44 the identity of the data slots to be preserved.

Another possibility is that during the communication over the communication link 48 the remote equipment sends data to the selection module 44 directly identifying which data slots to preserve during the termination operation.

Next, the selection module 44 will output the control information about which data slots to preserve at the output 40 that is conveyed to the overhead processor 32 via control input 34.

The arrangement illustrated in FIG. 4 suggests that the database server 50 be remote from the module 42. A possible variation is to locate the database in the selection module 44.

The termination operation performed by the overhead processor 32 can be effected such that the data in the data slots designated for preservation can be written in the data slots of the outgoing overhead component (the overhead component produced as a result of the termination operation) that correspond to the data slots of the incoming overhead component (the overhead component prior to the termination operation). Alternatively, the position of the data in the outgoing overhead component can be different from the position of the data in the incoming overhead component. Different position changes can be considered. One possibility is to retain the data to be preserved in the same overhead segment as the one from which the data came from (section overhead segment, line overhead segment or path overhead segment), albeit in a different data slot(s). Another possibility is to locate the data to be preserved in an overhead segment of the outgoing overhead component that is different from the overhead segment of the incoming overhead component. If such a position change is considered, information identifying the position of the data to be preserved in the outgoing overhead component may be provided in the database (either in the server 50 or in selection module 44). This information is communicated to the overhead processor 32 via the control input 34.

FIG. 5 illustrates yet another example of implementation where the module 52 has a selection module 54 communicating with a user interface 56. A user, at the user interface, specifies the data slots in the overhead component that are to be preserved. The user interface 56 includes any agency allowing a user to supply this information to the selection module 54. Examples of user interfaces include a display, touch sensitive screen, keyboard, pointing device and speech recognition. The user interface 56 may also include an input device that reads information magnetically, electrically or optically encoded on a removable storage media. In a possible variant, the user inputs at the user interface 56 information identifying the remote equipment that originates the data frames. By conducting a database search as described earlier, the identity of the data slots to be preserved can be identified.

The selection modules 38, 44 and 54 and the overhead processor 32 may be implemented in software, in hardware of a combination of software and hardware.

A detailed example of the operation of the module 42 shown at FIG. 4 will now be provided. Assume that module 42 is implemented at STE 18. STE 16 and LTE 20 are SONET compliant devices, however they are designed to communicate to one another by sending proprietary usage data inserted in the section overhead segment of each SONET data frame. The proprietary usage data is placed

Before the STE 16 starts sending SONET data frames 24 to the STE 18, STE 18 communicates with STE 16 to determine its identity. Specifically, the selection module 44 performs an auto-discovery procedure and identifies the presence of STE 16. Next, selection module 44 sends a message to database server 50 to communicate to the database server 50 the identity of the STE 16. The database server 50 searches its database and determines that STE 16 is constructed such as to use for example, D1, D2 and D3 of STS-1 #2 for proprietary purposes; hence these data slots should be designated for preservation. The identification of the data slots is sent back to the selection module 44 over communication link 48, which then generates the control information released from output 40, and which arrives at control input 34.

During the operation of the STE 18, data frames are received at its data input. The data frames are passed to the overhead processor 32 which will perform the selective termination operation. Here the operation involves regenerating the section overhead segment, leaving the line and path overhead segments unchanged. The selective termination involves reading the data in the data slot designated for preservation, performing the regeneration of the section overhead segment and then writing the data in the same data slot of the section overhead segment, after the regeneration. Finally, the overhead processor 32 will assemble a SONET data frame 24 using the new section overhead segment and will release the SONET data frame 24 from the data output of the STE 16.

In the various examples given above, it will be noted that LTE 14, STE 16, STE 18 and LTE 20 receive at their data inputs SONET data frames 24 and release from their data inputs SONET data frames 24. PTE 12 and PTE 22 function somewhat differently in that PTE 12 receives at its data input non-SONET data frames and PTE 22 releases non-SONET data frames from its data output. It will be plain to a person skilled in the art that the principles of this invention still apply to those cases.

Although various embodiments have been illustrated, this was for the purpose of describing, but not limiting, the invention. Various modifications will become apparent to those skilled in the art and are within the scope of this invention, which is defined more particularly by the attached claims. For instance, the specific examples presented above pertain to terminating equipment operating in a SONET network. The skilled person in the art will readily appreciate that terminating devices operating in an SDH network or other similar network may be constructed on the basis of the description provided below without detracting from the spirit of the invention.

1) A termination equipment, comprising:
a) a data input for receiving a plurality of data frames, each data frame including an overhead component and a payload component, the overhead component including a plurality of data slots;
b) an overhead processor in communication with said data input, said overhead processor including a control input to receive control information designating at least one data slot among the plurality of data slots of each overhead component for preservation;
c) said overhead processor being responsive to the control information to perform a selective termination operation on the plurality of data frames preserving data in the at least one data slot designated for preservation of the overhead component of each data frame;
d) the selective termination operation producing an output data stream containing payload data from the payload components of the plurality of data frames and data from the at least one data slot designated for preservation of the overhead component of each data frame;
e) an output in communication with said overhead processor to release the output data stream.

2) A termination equipment as defined in claim 1, wherein the data frames are SONET data frames.

3) A termination equipment as defined in claim 2, wherein said selective termination operation includes a section termination operation.

4) A termination equipment as defined in claim 3, wherein said selective termination operation includes a line termination operation.

5) A termination equipment as defined in claim 4, wherein said selective termination operation includes a path termination operation.

6) A termination equipment as defined in claim 3, including a selection module generating the control information, said selection module being in communication with said control input to supply the control information to said control input.

7) A termination equipment as defined in claim 6, wherein said selection module is operative to:
a) analyze data in one or more data slots of overhead components of data frames at said data input;
b) select on the basis of the analyzing one or more data slots for preservation;
c) generate the control information designating the one or more data slots selected for preservation.

8) A termination equipment as defined in claim 6, wherein the data frames at said input are produced by a remote equipment, said selection module being operative to:
a) identify the remote equipment;
b) select on the basis of the identifying of the remote equipment one or more data slots for preservation;
c) generate the control information designating the one or more data slots selected for preservation.

9) A termination equipment as defined in claim 6, wherein the data frames at said input are produced by a remote equipment, said selection module being operative to:
a) receive from the remote equipment data identifying one or more data slots for preservation;
b) generate the control information designating the one or more data slots identified for preservation.

10) A termination equipment as defined in claim 8, wherein said selection module identifies the remote equipment by performing an auto-discovery procedure.

11) A termination equipment as defined in claim 8, wherein the selection of the one or more data slots for preservation includes searching a database that associates different remote equipments with data slots for preservation.

12) A termination equipment as defined in claim 11, wherein the database resides in said termination equipment.

13) A termination equipment as defined in claim 11, wherein the database is remote from said selection module.

14) A termination equipment as defined in claim 6, including a user interface allowing a user to enter information designating at least one data slot for preservation.

15) A termination equipment as defined in claim 14, wherein said user interface includes an input device that reads information magnetically, electrically or optically encoded on a removable storage media.

16) A termination equipment, comprising:
a) data input means for receiving a plurality of data frames, each data frame including an overhead component and a payload component, the overhead component including a plurality of data slots;
b) an overhead processor means in communication with said data input means, said overhead processor means including a control input to receive control information designating at least one data slot among the plurality of data slots of the overhead component of each data frame for preservation;
c) said overhead processor means being responsive to the control information to perform a selective termination operation on the data frames preserving data in the at least one data slot of the overhead component designated for preservation of each data frame;
d) the selective termination operation producing an output data stream containing payload data from the payload components of the plurality of data frames and data from the at least one data slot of the overhead component designated for preservation in each data frame;
e) output means in communication with said overhead processor means to release the output data stream.

17) A method for processing data frames, each data frame including an overhead component and a payload component, the overhead component including a plurality of data slots, said method comprising:
a) receiving the data frames at a data input;
b) receiving control information designating at least one data slot among the plurality of data slots for preservation;
c) performing selective termination on the data frames on the basis of the control information to produce an output data stream containing payload data from the payload components of the plurality of data frames and data from the at least one data slot of the overhead component designated for preservation in each data frame.

18) A method as defined in claim 17, wherein the data frames are SONET data frames.

19) A method as defined in claim 18, wherein said selective termination operation includes a section termination operation.

20) A method as defined in claim 19, wherein said selective termination operation includes a line termination operation.

21) A method as defined in claim 20, wherein said selective termination operation includes a path termination operation.

22) A method as defined in claim 19, including:
a) analyzing data in one or more data slots of overhead components of the plurality of data frames;
b) selecting on the basis of the analyzing one or more data slots for preservation;
c) generating the control information designating the one or more data slots selected for preservation.

23) A method as defined in claim 19, wherein the plurality of data frames at the input are issued by a remote equipment, said method including:
a) identifying the remote equipment;
b) determining on the basis of the identifying of the remote equipment one or more data slots for preservation in the overhead components of the plurality of data frames;
c) generating the control information designating the one or more data slots selected for preservation.

24) A method as defined in claim 19, wherein the data frames at said input are produced by a remote equipment, said method including:
a) receiving from the remote equipment data identifying one or more data slots for preservation;
b) generating the control information designating the one or more data slots identified for preservation.

25) A termination equipment as defined in claim 19, wherein the control information is derived from a user interface allowing a user to enter information selecting at least one data slot for preservation.
